(19) United States
(12) Patent Application Publication
(10) Pub. No.: US 2020/0283626 A1
(43) Pub. Date: Sep. 10, 2020

(54) IMPACT-MODIFIED POLY(ARYLENE SULFIDE) COMPOSITIONS

(71) Applicant: SOLVAY SPECIALTY POLYMERS USA, LLC, Alpharetta, GA (US)

(72) Inventor: William E. SATTICH, Cumming, GA (US)

(21) Appl. No.: 16/764,000

(22) PCT Filed: Nov. 30, 2018
(86) PCT No.: PCT/EP2018/083195

§ 371 Date: May 14, 2020

Related U.S. Application Data
(60) Provisional application No. 62/592,879, filed on Nov. 30, 2017.

(51) Int. Cl. C08L 81/02; C08K 7/14; B33Y 70/10; B29C 45/00

(52) U.S. Cl. CPC C08L 81/02; C08K 7/14; B33Y 70/10; B29K 2081/04; C08L 2205/025; C08L 2205/035; B29C 45/0001

(57) ABSTRACT

Methods of making a polymer composition, the method including (i) contacting a poly(arylene sulfide) (PAS) with an aqueous solution including zinc ions, preferably during recovery of the PAS following polymerization, and ii) contacting the PAS with an ethylene copolymer impact modifier. Also described are polymer compositions made by the method, and shaped articles including the polymer composition.

This application claims priority to U.S. provisional patent application application No. 62/592,879 filed Nov. 30, 2017, the whole content of this application being incorporated herein by reference for all purposes.

### FIELD OF THE INVENTION

The present invention relates to methods of making a polymer composition, the method including (i) contacting a poly(arylene sulfide) (PAS) with an aqueous solution including zinc ions, preferably during recovery of the PAS following polymerization, and ii) contacting the PAS with an ethylene copolymer impact modifier. Also described are polymer compositions made by the method, and shaped articles including the polymer composition.

### BACKGROUND

Poly(arylene sulfides) (PAS) are high temperature semi-crystalline engineering polymers with excellent chemical resistance, high heat deflection temperature, good electrical insulation properties, and inherent flame resistance.

PAS are often injection molded into components for use in a variety of applications such as under-hood automotive and electrical applications. Injection molding cycle times are highly dependent on the crystallization kinetics of the material being injected, with faster crystallization kinetics yielding faster cycle times and increased production rates. Thus, higher production rates of injection molded components can be achieved with PAS compositions having a high melt crystallization temperature (Tmc) (i.e. a Tmc≥225° C. as measured by differential scanning calorimetry (DSC) according to ASTM D3418) than with PAS compositions having a lower Tmc.

Formulations including acetic-acid-washed PAS may exhibit a high Tmc, and, therefore, faster crystallization kinetics than water-washed PAS formulations. Nevertheless, when the composition includes an ethylene copolymer impact modifier, the high Tmc is not observed in acetic-acid-washed PAS compositions.

Accordingly, a need exists for impact-modified PAS compositions that also exhibit faster crystallization kinetics.

### DETAILED DESCRIPTION OF PREFERRED EMBODIMENTS

Described herein is a method of making a polymer composition, the method including (i) contacting a PAS with an aqueous solution including zinc ions to increase the zinc content of the PAS to at least 1000 ppm as measured by Inductively Coupled Plasma Optical Emission Spectrometry (ICP-OES), and ii) contacting the PAS with an ethylene copolymer impact modifier. Also described are polymer compositions made by the method, and shaped articles including the polymer composition.

Conventional processes to make PAS result in the PAS having a zinc content of less than 1000 ppm as measured by ICP-OES. Applicants surprisingly discovered that significantly improved crystallization kinetics are achieved in PAS compositions including an ethylene copolymer impact modifier when the PAS is contacted with an aqueous solution including zinc ions so that the zinc content of the PAS is increased to at least 1000 ppm as measured by ICP-OES as described in the Examples below. Subsequent to the contacting, the zinc content of the PAS is preferably increased to at least 1100 ppm, 1200 ppm, 1300 ppm, 1400 ppm, 1500 ppm, and most preferably at least 1600 ppm. All zinc contents described herein are measured by ICP-OES as described in the Examples. Preferably, all of the zinc content of the PAS, more preferably all of the zinc content of the polymer composition, and most preferably both, is derived from the zinc ions in the aqueous solution.

The aqueous solution including zinc ions can be any water-based solution that includes free zinc cations with the ability to form ionic bonds to the terminal groups of the PAS through ion exchange. The aqueous solution including zinc ions may further include cations or anions different from the zinc ions. Preferably, the aqueous solution including zinc ions is a solution of zinc acetate in water, although other water-soluble zinc-containing salts may also be used. The concentration of zinc ions in the aqueous solution including zinc ions should be sufficient to raise the zinc content of the PAS to at least 1100 ppm, 1200 ppm, 1300 ppm, 1400 ppm, 1500 ppm, and most preferably at least 1600 ppm. In some embodiments, the concentration of zinc ions in the aqueous solution is at least 0.01 M.

The PAS is preferably contacted with the aqueous solution including zinc ions prior to inclusion of the PAS in the polymer composition (e.g., prior to the PAS contacting the ethylene copolymer impact modifier or other ingredients in the polymer composition).

Methods of PAS production, specifically poly(para-phenylene sulfide) (PPS) production, are known in the art and are described in more detail, for example, in U.S. Pat. Nos. 3,919,177; 3,354,129; 4,038,261; 4,038,262; 4,038,263; 4,064,114; 4,116,947; 4,282,347; 4,350,810; and 4,808,694; each of which is incorporated by reference herein in its entirety. General conditions for the production of PAS (e.g. PPS) are described, for example, in U.S. Pat. Nos. 5,023,315; 5,245,000; 5,438,115; and 5,929,203; each of which is incorporated by reference herein in its entirety.

In some embodiments, the contacting the PAS with the aqueous solution containing zinc ions can be incorporated into the PPS recovery phase subsequent to polymerization. Generally, the PAS production process includes a polymerization phase in which PAS is synthesized by contacting at least one halogenated aromatic compound having two halogens, a sulfur compound, and a polar organic compound to form a precipitate of the PAS in a reaction mixture slurry. Subsequently, during the recovery phase, the synthesized PAS particles (e.g., PPS particles) are recovered from the reaction mixture slurry and purified by any process capable of separating and purifying a solid particulate from a liquid. The PAS production process can form an alkali metal halide by-product. The by-product alkali metal halide can be removed and the PAS purified during the recovery phase of the PAS (e.g., PPS).

In some embodiments, the PAS is contacted with the aqueous solution including zinc ions during the recovery phase of the process to make the PAS. For example, the aqueous solution including zinc ions can be used as the aqueous solution one or more times during the recovery phase as described below.

The recovery phase may include one or more steps during which the PAS is contacted with an aqueous solution (e.g. washed with an aqueous solution) as described below. For example, procedures which can be utilized to recover the PAS particles from the reaction mixture slurry can include, i) filtration, ii) washing the PAS with a liquid (e.g., water or aqueous solution), or iii) dilution of the reaction mixture with liquid (e.g., water or aqueous solution) followed by filtration and washing the PAS with a liquid (e.g., water or aqueous solution). For example, the reaction mixture slurry can be filtered to recover the PAS (e.g., the PPS) particles, which can be slurried in a liquid (e.g., water or aqueous solution) and subsequently filtered to remove the alkali metal halide by-product (and/or other liquid, e.g., water, soluble impurities). Generally, the steps of slurrying the PAS with a liquid followed by filtration to recover the PAS can occur as many times as necessary to obtain a desired level of purity of the PAS, and the PAS can be washed with one or more aqueous solutions.

One or more the aqueous solutions described in the preceding paragraph can be the aqueous solution including zinc ions.

In some embodiments, the aqueous solution including zinc ions is a wash solution, and the PAS is contacted with the aqueous solution including zinc ions in one or more steps during the recovery phase of the PAS as described above. The PAS may be contacted (e.g. washed) with the aqueous solution including zinc ions one, two, three, or more times. Preferably the PAS is contacted (e.g. washed) with the aqueous solution including zinc ions more than one time. The PAS is contacted with the aqueous solution including zinc ions a sufficient number of times, or for a sufficient total time, to raise the zinc content of the PAS to at least 1000 ppm, 1100 ppm, 1200 ppm, 1300 ppm, 1400 ppm, 1500 ppm, and most preferably at least 1600 ppm at the end of the recovery phase.

In some embodiments, contacting the PAS with the aqueous solution including zinc ions (e.g. washing the PAS with the aqueous solution including zinc ions as described herein) increases the zinc content of the PAS and reduces the concentration of the alkali metal halide by-product (e.g. separates the alkali metal halide by-product from the PAS).

After contact with the aqueous solution including zinc ions, the melt crystallization temperature (Tmc) of the PAS is preferably at least 225° C. In some embodiments, the Tmc of the PAS is at least 226° C. In some embodiments, the Tmc of the PAS is at least 229° C. The Tmc of the PAS when the PAS is included in the polymer composition (e.g., after the PAS contacts the ethylene copolymer impact modifier or other ingredients in the polymer composition) is preferably at least 225° C., preferably at least at least 226° C. In some embodiments, the Tmc of the PAS when the PAS is included in the polymer composition is at least 229° C. Tmc is measured by differential scanning calorimetry (DSC) according to ASTM D3418, as described in the examples below.

The high Tmc exhibited by the PAS after it is contacted (e.g., washed) with the aqueous solution including zinc ions described herein was unexpectedly found to impart improved crystallization kinetics to polymer compositions including the PAS and an ethylene copolymer impact modifier. The enhanced crystallization kinetics of the inventive polymer compositions allow for faster injection molding cycle times and associated increased production rates.

The polymer composition can be made by methods well known to the person of skill in the art. For example, such methods include, but are not limited to, melt-mixing processes. Melt-mixing processes are typically carried out by heating the polymer components above the melting temperature of the thermoplastic polymers thereby forming a melt of the thermoplastic polymers. Suitable melt-mixing apparatus are, for example, kneaders, Banbury mixers, single-screw extruders, and twin-screw extruders. Preferably, use is made of an extruder fitted with means for dosing all the desired components to the extruder, either to the extruder's throat or to the melt. In the process for the preparation of the polymer composition, the components of the polymer composition, e.g. the PAS, the ethylene copolymer impact modifier, optional reinforcing fillers, and optional additives, are fed to the melt-mixing apparatus and melt-mixed in the apparatus. The components may be fed simultaneously as a powder mixture or granule mixture, also known as dry-blend, or may be fed separately.

The order of combining the components during melt-mixing is not particularly limited. In one embodiment, the component can be mixed in a single batch, such that the desired amounts of each component are added together and subsequently mixed. In other embodiments, a first sub-set of components can be initially mixed together and one or more of the remaining components can be added to the mixture for further mixing. For clarity, the total desired amount of each component does not have to be mixed as a single quantity. For example, for one or more of the components, a partial quantity can be initially added and mixed and, subsequently, some or all of the remainder can be added and mixed.

### Poly(Arylene Sulfide) (PAS)

As used herein, “poly(arylene sulfide) (PAS)” means any polymer of which at least 50 mol % of the recurring units are recurring units (R_{PAS}) of formula —(Ar—S)—, where Ar is an aromatic group. Preferably at least 70 mol %, 80 mol %, 90 mol %, 95 mol %, 99 mol % of recurring units in the PAS are recurring units (R_{PAS}) of formula —(Ar—S)—. For clarity, as used herein, mole percent is relative to the total number of recurring units in the polymer, unless explicitly indicated otherwise.

As used herein, a “poly(para-phenylene sulfide) (PPS)” denotes any polymer of which at least 50 mol % of recurring units are recurring units (R_{PPS}) of formula (A):

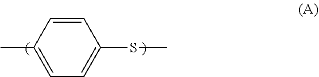

Preferably at least 70 mol %, 80 mol %, 90 mol %, 95 mol %, 99 mol % of the recurring units in the PPS are recurring units (R_{PPS}) of formula A.

In some embodiments, the PAS comprises poly(2,4-toluene sulfide), poly(4,4′-biphenylene sulfide), poly(para-phenylene sulfide) (PPS), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecylphenylene sulfide), poly(phenylphenylene sulfide), poly-(tolylphenylene sulfide), poly(benzylphenylene sulfide), poly[octyl-4-(3-methylcyclopentyl)phenylene sulfide], or a combination thereof. Preferably, the PAS is poly(para-phenylene sulfide) (PPS).

PPS is manufactured and sold under the trade name Ryton® by Solvay Specialty Polymers USA, L.L.C.

Unless otherwise indicated, any amount in weight percent described herein is relative to the total weight of the polymer composition. Preferably, the polymer composition includes more than 50 wt. %, preferably at least 60 wt. % of the PAS (e.g. the PPS). Additionally or alternatively, in some embodiments, the PAS polymer includes no more than 90 wt. %, preferably no more than 80 wt. %, of the PAS. In some embodiments, the amount of PAS in the polymer composition ranges from 60 wt. % to 90 wt. %, preferably from 60 wt. % to 80 wt. %.

In some embodiments, the amount of PAS in the polymer composition that has been contacted with the aqueous solution including zinc ions as described herein is at least 50 wt. %, preferably at least 60 wt. %, 70 wt. %, 80 wt. %, 90 wt. %, and most preferably at least 99 wt. %, based on the total weight of the PAS in the polymer composition.

### Ethylene Copolymer Impact Modifier

The polymer composition includes an ethylene copolymer impact modifier. As used herein, “copolymer” means a polymer containing two or more distinct repeat units, and includes terpolymers. The ethylene copolymer impact modifier comprises at least at least 50 wt. %, preferably at least 55 wt. %, preferably at least 60 wt. % of ethylene repeat units.

Preferably, the ethylene copolymer impact modifier includes 50 wt. % or less, preferably 45 wt. % or less, preferably 40 wt. % or less of repeat units comprising a (meth)acrylate group.

In some embodiments, the ethylene copolymer impact modifier comprises (i) at least 50 wt. % of ethylene, (ii) 0-50 wt. % of a C1-C12 alkyl (meth)acrylate, or a vinyl ether, and (iii) 0-50 wt. % of an unsaturated C4-C11 epoxide, preferably glycidyl acrylate, glycidyl methacrylate (GMA), allyl glycidyl ether, vinyl glycidyl ether, or a glycidyl itaconate, or an unsaturated C2-C11 isocyanate, preferably a vinyl isocyanate or isocyanato-ethyl methylacrylate.

In some embodiments, the ethylene copolymer impact modifier comprises (i) at least 55 wt. %, preferably at least 60 wt. % of ethylene, (ii) 0.5-35% wt. % of a C1-C12 alkyl (meth)acrylate, preferably methyl acrylate, iso-butyl acrylate, or n-butyl acrylate, and (iii) 0.5-10 wt. % of an unsaturated C4-C11 epoxide, preferably glycidyl methacrylate or glycidyl acrylate.

In an alternative embodiment, the ethylene copolymer impact modifier comprises (i) at least 50 wt. %, preferably at least 60 wt. % of ethylene, and (ii) less than 50 wt. %, preferably less than 40 wt. % of a C1-C12 alkyl (meth)acrylate, preferably methyl acrylate, iso-butyl acrylate, or n-butyl acrylate.

The most preferred ethylene copolymer impact modifiers are those selected from the group consisting of ethylene/acrylate/glycidyl methacrylate, ethylene/glycidyl methacrylate, ethylene/ethylene butyl acrylate, ethylene/ethylene acrylate, ethylene/methyl acrylate, and combinations thereof.

In some embodiments the impact modifier is a random copolymer of ethylene and glycidyl methacrylate, and/or a random terpolymer of ethylene, methyl acrylate, and glycidyl methacrylate. Examples of such copolymers include, respectively, Lotader® AX 8840 and Lotader® AX 8900, which are available from Arkema.

In some embodiments, the ethylene copolymer impact modifier is a random copolymer of ethylene, and ethylene butyl acrylate, ethylene and ethylene acrylate, or ethylene and methyl acrylate. Examples of such copolymers are Elvaloy® AS copolymers available from Dupont.

In some embodiments, the ethylene copolymer impact modifier is an ionomer of ethylene acid acrylate terpolymer, preferably a zinc ionomer of ethylene acid acrylate terpolymer. Such terpolymers are available as Surlyn® from Dupont.

The polymer composition may include one, two, or more ethylene copolymer impact modifiers.

In some embodiments, the ethylene copolymer impact modifier is 0.5 wt. % to 30 wt. %, preferably 1 wt. % to 25 wt. %, preferably 1 wt. % to 20 wt. %, 1 wt. % to 15 wt. %, 1 wt. % to 10 wt. %, 1 wt. % to 7 wt. %, 1 wt. % to 6 wt. %, 5 wt. % to 6 wt. %, based on the total weight of the polymer composition.

In some embodiments, the polymer composition has a notched-Izod impact resistance of at least 10 kJ/m² as measured according to ISO 180/A.

### Optional Reinforcing Fillers

The polymer composition may optionally include reinforcing fillers such as fibrous or particulate fillers. A fibrous reinforcing filler is a material having length, width and thickness, wherein the average length is significantly larger than both the width and thickness. Preferably, such a material has an aspect ratio, defined as the average ratio between the length and the smallest of the width and thickness of at least 5. Preferably, the aspect ratio of the reinforcing fibers is at least 10, more preferably at least 20, still more preferably at least 50. The particulate fillers have an aspect ratio of at most 5, preferably at most 2.

Preferably, the reinforcing filler is selected from mineral fillers, such as talc, mica, kaolin, calcium carbonate, calcium silicate, magnesium carbonate, boron nitride; glass fibers; carbon fibers, boron carbide fibers; wollastonite; silicon carbide fibers; boron fibers, graphene, carbon nanotubes (CNT), and the like. Most preferably, the reinforcing filler is glass fiber, preferably chopped glass fiber, or carbon fiber, preferably chopped carbon fibers.

The amount of the reinforcing filler may range in the case of particulate fillers, from 1 wt. % to 40 wt. %, preferably from 5 wt. % to 35 wt. % and most preferably from 10 wt. % to 30 wt. %, and in the case of fibrous fillers from 5 wt. % to 50 wt. %, preferably from 10 wt. % to 40 wt. %, and most preferably from 15 wt. % to 30 wt. % based on the total weight of the polymer composition. Preferably, the polymer composition includes from 20 to 60 wt. %, preferably from 20 to 50 wt. %, 25 to 35 wt. %, most preferably about 30 wt. %, of glass or carbon fiber, most preferably glass fiber. In some embodiments, the polymer composition is free of a fibrous filler, a particulate filler, or both.

### Optional Additives

The polymer composition may further include optional additives such as titanium dioxide, ultraviolet light stabilizers, heat stabilizers, antioxidants such as organic phosphites and phosphonites, acid scavengers, processing aids, nucleating agents, lubricants, flame retardants, smoke-suppressing agents, anti-static agents, anti-blocking agents, and conductivity additives such as carbon black.

When one or more optional additives are present, their total concentration is preferably less than 10 wt. %, more preferably less than 5 wt. %, and most preferably less than 2 wt. %.

### Shaped Articles and Methods of Making

Exemplary embodiments also include shaped articles comprising the polymer composition and methods of making the shaped articles.

The polymer composition may be well suited for the manufacture of articles useful in a wide variety of applications. The shaped articles may be made from the polymer composition using any suitable melt-processing method such as injection molding, extrusion molding, roto-molding, or blow-molding; however, the crystallization kinetics and toughness of the polymer composition makes it especially suitable for use in injection molded parts, for example, automotive under-hood and chassis components such fluid pump components, overmolded sensors, electric motor components and plumbing components such as plumbing pumps valves, manifolds, and meters.

Exemplary embodiments are also directed to methods of making shaped articles by additive manufacturing, where the shaped article is printed from the polymer composition. The methods include printing layers of the shaped article from the polymer composition as described below.

Additive manufacturing systems (e.g. 3D printing systems) are used to print or otherwise build a shaped object from a digital representation of the shaped object by one or more additive manufacturing techniques. Examples of commercially available additive manufacturing techniques include extrusion-based techniques, selective laser sintering, powder/binder jetting, electron-beam melting, and stereolithography processes. For each of these techniques, the digital representation of the shaped object is initially sliced into multiple horizontal layers. For each layer, a tool path is then generated, which provides instructions for the particular additive manufacturing system to print the given layer.

Accordingly, some embodiments include a method of making a shaped article comprising printing layers of the polymer composition to form the shaped article by an extrusion-based additive manufacturing system (for example FFF), a powder-based additive manufacturing system (for example SLS), or a continuous Fiber-Reinforced Thermosplastic (FRTP) printing method.

Exemplary embodiments will now be described in the following non-limiting examples.

### EXAMPLES

The tensile properties, impact strength, and melt crystallization temperature (Tmc) were evaluated for a variety of polymer compositions.

### Materials

### PPS

Ryton® PPS QA250N (acetic acid washed), melt flow rate assessed according to ASTM D1238B at 316° C. with a 5 kg weight (MFR) of 430 g/10 min, available from Solvay Specialty Polymers USA, L.L.C.

PPS (deionized water washed), MFR 140 g/10 min.

PPS (zinc acetate washed), MFR 136 g/10 min.

PPS (KOH washed), MFR 160 g/10 min.

Ryton® PPS QC220N (calcium acetate washed), MFR 175 g/10 min.

Ethylene Copolymer Impact Modifiers

Lotader® AX8840, a random copolymer of ethylene and glycidyl methacrylate (8 wt. %) available from Arkema.

Lotader® AX8900, a random terpolymer of ethylene, methyl acrylate (24 wt. %), and glycidyl methacrylate (8 wt. %), available from Arkema.

Elvaloy® AS, an ethylene/butyl acrylate/glycidyl methacrylate terpolymer available from Dupont.

Surlyn® 9320W, a zinc ionomer of ethylene acid acrylate terpolymer (partially neutralized zinc salt) available from Dupont.

### Antioxidant

Irganox® 1010, available from BASF.

### Organofuctional Silanes

Silane Silquest A-1524, available from Momentive Performance Materials, Inc.

Silane Silquest A-187, available from Momentive Performance Materials, Inc.

### High Density Polyethylene (HDPE)

Marlex® 6007 supplied by Chevron Phillips Chemical Company

Preparation of Deionized Water Washed PPS

Deionized water washed PPS was synthesized and recovered from the reaction mixture according to methods described in U.S. Pat. Nos. 3,919,177 and 4,415,729, and washed twice with deionized water for at least 5 minutes at 60° C.

Preparation of Zinc Acetate Washed PPS

Zinc acetate washed PPS was synthesized and recovered from the reaction mixture according to methods described in U.S. Pat. Nos. 3,919,177 and 4,415,729, washed twice with deionized water for at least 5 minutes at 60° C., then washed once with 0.01 mol/L aqueous zinc acetate solution for at least 5 minutes at 60° C., and then washed once again with deionized water for at least 5 minutes at 60° C.

Preparation of Potassium Hydroxide Washed PPS

Potassium hydroxide washed PPS was synthesized and recovered from the reaction mixture according to methods described in U.S. Pat. Nos. 3,919,177 and 4,415,729, washed twice with deionized water for at least 5 minutes at 60° C., then washed once with 0.02 mol/L aqueous potassium hydroxide solution for at least 5 minutes at 60° C., and then washed once again with deionized water for at least 5 minutes at 60° C.

### Compounding

The compositions shown in Tables 1, 2, and 3 below were compounded using a Coperion® ZSK-26 co-rotating twin-screw extruder having an L/D ratio of 48:1 at 200 rpm and 16-18 kg/hr. Barrel temperature set points were 305° C. and the die temperature set points were 300° C.

Evaluation of Thermal and Mechanical Properties

The melt flow rates of PPS polymers were determined according to ASTM D1238B, at 316° C. with 5 kg weight.

The content of zinc in the PPS polymers was determined by Inductively Coupled Plasma Optical Emission Spectrometry (ICP-OES) analysis of dilute acid solutions of the combustion residue of the polymer. For each sample, approximately 1 g was weighed on an analytical balance into a platinum crucible and then ashed overnight in a laboratory furnace. The sample crucibles were placed on a hot plate and any residue leached with dilute hydrochloric acid for about 30 min at a hot plate setting of about 260° C. After cooling, the contents of each crucible was quantitatively transferred to 25 ml volumetric flasks and brought to volume with deionized water. The sample extracts were then analyzed by ICP-OES (Perkin Elmer Optima 8300) using the Semi-Quantitative Metal Survey method.

The temperature of crystallization from the melt (Tmc) of PPS polymer in compositions were determined by Differential Scanning calorimetry according to ASTM D3418, heated to 350° C. at 20° C./min and then cooled at 20° C./min.

Test specimens were injection molded from the compositions according to ISO 294 at a melt temperature of 300° C. to 350° C. and mold temperature of 135° C. to 150° C.

Tensile strain at yield, tensile strain at break, tensile stress at yield, tensile stress at break, and tensile modulus were determined according to ISO 527 using injection molded test specimens.

Notched Izod impact strength was determined by ISO 180/A using injection molded test specimens.

The polymer compositions and test results for the Examples and Comparative Examples are shown in Tables 1-3 below.

TABLE 1

| | C1 | C2 | E3 | C4 | C5 | C6 | E7 |
|---|---|---|---|---|---|---|---|
| Polymer Composition (wt. %) | | | | | | | |
| Ryton ® PPS QA250N | 79.00 | — | — | 62.75 | — | — | — |
| (acetic acid washed) | | | | | | | |
| PPS (water washed) | — | 79.00 | — | — | 62.75 | — | — |
| PPS (zinc acetate washed) | — | — | 79.00 | — | — | — | 62.75 |
| PPS (KOH washed) | — | — | — | — | — | 62.75 | — |
| Glass Fiber | — | — | — | 30.00 | 30.00 | 30.00 | 30.00 |
| Lotader ® AX8840 | 20.00 | 20.00 | 20.00 | 6.00 | 6.00 | 6.00 | 6.00 |
| Irganox ® 1010 | 1.00 | 1.00 | 1.00 | 0.50 | 0.50 | 0.50 | 0.50 |
| Silane Silquest A-1524 | — | — | — | 0.50 | 0.50 | 0.50 | 0.50 |
| HDPE 6007G | — | — | — | 0.25 | 0.25 | 0.25 | 0.25 |
| PPS Wash | acetic | water | zinc | acetic | water | KOH | zinc |
| | acid | | acetate | acid | | | acetate |
| PPS Tmc, ° C. | 189 | 199 | 225 | 220 | 212 | 201 | 230 |
| Zn in PPS (ppm) | <10 | <10 | 1630 | <10 | <10 | <10 | 1630 |
| Mechanical Properties | | | | | | | |
| Yield Strain, % | 6.60 | 6.10 | 6.60 | — | — | — | — |
| Break Strain, % | 18 | 19 | 23 | 2.4 | 2.3 | 2.2 | 2.2 |
| Yield Strength, MPa | 49.0 | 49.4 | 49.4 | — | — | — | — |
| Break Strength, MPa | 46.0 | 43.6 | 43.5 | 149 | 144 | 141 | 141 |
| Modulus, MPa | 1980 | 2060 | 2060 | 10800 | 10000 | 9980 | 10100 |
| Notched Izod, kJ/m² | 28.4 | 29.7 | 42.5 | 13.4 | 11.6 | 10.8 | 10.3 |

Examples C1, C2, and E3 show unfilled compositions including PPS washed with acetic acid, water, and zinc acetate, respectively. As shown above, the composition of Example E3 with zinc-acetate-washed PPS unexpectedly exhibited a markedly higher melt crystallization temperature (Tmc) of 225° C., as compared with that of Comparative Examples C1 and C2 (189° C. and 199° C., respectively). Examples C4, C5, C6 and E7 show glass-fiber-filled compositions including PPS washed with acetic acid, water, potassium hydroxide, and zinc acetate, respectively. As shown above, the composition of Example E7 with zinc-acetate-washed PPS unexpectedly exhibited a significantly higher Tmc of 230° C., as compared with that of Comparative Examples C4, C5, and C6 (220° C., 212° C., and 201° C., respectively).

TABLE 2

| | C8 | C9 | C10 | E11 | C12 | C13 | C14 | E15 |
|---|---|---|---|---|---|---|---|---|
| Polymer | | | | | | | | |
| Composition | | | | | | | | |
| (wt. %) | | | | | | | | |
| Ryton ® PPS | 62.75 | — | — | — | 62.75 | — | — | — |
| QA250N | | | | | | | | |
| (acetic acid washed) | | | | | | | | |
| PPS (water washed) | — | 62.75 | — | — | — | 62.75 | — | — |
| PPS (zinc acetate | — | — | — | 62.75 | — | — | — | 62.75 |
| washed) | | | | | | | | |
| Ryton ® PPS | — | — | 62.75 | — | — | — | 62.75 | — |
| QC220N | | | | | | | | |
| (calcium acetate | | | | | | | | |
| washed) | | | | | | | | |
| Glass Fiber | 30.00 | 30.00 | 30.00 | 30.00 | 30.00 | 30.00 | 30.00 | 30.00 |
| Lotader ® AX8900 | 6.00 | 6.00 | 6.00 | 6.00 | — | — | — | — |
| Elvaloy ® AS | — | — | — | — | 5.00 | 5.00 | 5.00 | 5.00 |
| Surlyn ® 9320W | — | — | — | — | 1.00 | 1.00 | 1.00 | 1.00 |
| Irganox ® 1010 | 0.50 | 0.50 | 0.50 | 0.50 | 0.50 | 0.50 | 0.50 | 0.50 |
| Silane Silquest A- | 0.50 | 0.50 | 0.50 | 0.50 | 0.50 | 0.50 | 0.50 | 0.50 |
| 187 | | | | | | | | |
| HDPE 6007G | 0.25 | 0.25 | 0.25 | 0.25 | 0.25 | 0.25 | 0.25 | 0.25 |
| PPS Wash | acetic | water | calcium | zinc | acetic | water | calcium | zinc |
| | acid | | acetate | acetate | acid | | acetate | acetate |
| PPS Tmc, ° C. | 216 | 221 | 214 | 229 | 213 | 217 | 209 | 229 |
| Zn in PPS (ppm) | <10 | <10 | <10 | 1630 | <10 | <10 | <10 | 1630 |
| Mechanical | | | | | | | | |
| Properties | | | | | | | | |
| Yield Strain, % | 2.1 | 1.6 | 1.8 | 1.9 | 2.2 | 2.1 | 2.0 | 2.0 |
| Break Strength, MPa | 153 | 127 | 135 | 139 | 154 | 142 | 142 | 141 |
| Modulus, MPa | 10600 | 9870 | 10200 | 10300 | 10300 | 10000 | 10100 | 10200 |
| Notched Izod, kJ/m² | 14.1 | 7.9 | 9.9 | 11.3 | 13.3 | 10.7 | 11.2 | 10.8 |

Examples C8, C9, C10, and E11 show glass-fiber-filled compositions with a different impact modifier (Lotader® AX8900) than was used in the previous examples and including PPS washed with acetic acid, water, calcium acetate, and zinc acetate, respectively. As shown in Table 2 above, the composition of Example E11 with zinc-acetate-washed PPS surprisingly exhibited a significantly higher Tmc of 229° C., as compared with that of Comparative Examples C8, C9, and C10 (216° C., 221° C., and 214° C., respectively).

Similarly, Examples C12, C13, C14, and E15 show glass-fiber-filled compositions with a different impact modifier (Elvaloy® AS) than was used in the previous examples and including PPS washed with acetic acid, water, calcium acetate, and zinc acetate, respectively. As shown in Table 2, the composition of Example E15 with zinc-acetate-washed PPS surprisingly exhibited a significantly higher Tmc of 229° C., as compared with that of Comparative Examples C12, C13, and C14 (213° C., 217° C., and 209° C., respectively).

TABLE 3

| | C20 | E21 |
|---|---|---|
| Polymer Composition (wt. %) | | |
| Ryton ® PPS QA250N | 41.75 | 21.00 |
| (acetic acid washed) | | |
| PPS (zinc acetate washed) | 21.00 | 41.75 |
| Glass Fiber | 30.00 | 30.00 |
| Elvaloy ® AS | 5.00 | 5.00 |
| Surlyn ® 9320W | 1.00 | 1.00 |
| Irganox ® 1010 | 0.50 | 0.50 |
| Silane Silquest A-187 | 0.50 | 0.50 |
| HDPE 6007G | 0.25 | 0.25 |
| PPS Wash | 2:1 | 1:2 |
| | acetic acid:zinc | acetic acid:zinc |
| | acetate | acetate |
| Tmc, ° C. | 216 | 226 |
| Zn in PPS (ppm) | 550 | 1090 |
| Mechanical Properties | | |
| Break Strain, % | 2.2 | 2.2 |
| Break Strength, MPa | 144 | 141 |
| Modulus, MPa | 9950 | 9890 |
| Notched Izod, kJ/m² | 13.40 | 12.20 |

Example E21 was a polymer composition including a 1:2 mixture of acetic-acid-washed PPS and zinc-acetate-washed PPS by weight. This polymer composition had a zinc content of just 1090 ppm, yet it unexpectedly exhibited a Tmc of 226° C., which is on par with that of the same polymer composition including only zinc-acetate-washed PPS (i.e., Example E15 with PPS zinc content of 1630 ppm and Tmc of 229° C.).

The embodiments above are intended to be illustrative and not limiting. Additional embodiments are within the inventive concepts. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

1. A method of making a polymer composition comprising:
(i) contacting a poly(arylene sulfide) (PAS) with an aqueous solution including zinc ions, wherein the contacting increases the zinc content of the poly(arylene sulfide) (PAS) to at least 1000 ppm as measured by Inductively Coupled Plasma Optical Emission Spectrometry (ICP-OES); and
(ii) contacting the poly(arylene sulfide) (PAS) with an ethylene copolymer impact modifier.

2. The method of claim 1, wherein the melt crystallization temperature (Tmc) of the poly(arylene sulfide) (PAS) is at least 225° C. as measured by differential scanning calorimetry (DSC) according to ASTM D3418 after contact with the aqueous solution including zinc ions.

3. The method of claim 1, wherein contacting the poly(arylene sulfide) (PAS) with the aqueous solution including zinc ions comprises washing particles of the poly(arylene sulfide) (PAS) with the aqueous solution including zinc ions during recovery of the poly(arylene sulfide) (PAS) following polymerization.

4. The method of claim 3, wherein washing the particles of the poly(arylene sulfide) (PAS) comprises removing an alkali metal halide.

5. The method of claim 1, wherein the aqueous solution including zinc ions further comprises dissolved zinc acetate.

6. The method of claim 1, wherein the poly(arylene sulfide) (PAS) is selected from the group consisting of poly(2,4-toluene sulfide), poly(4,4′-biphenylene sulfide), poly(para-phenylene sulfide) (PPS), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecylphenylene sulfide), poly(phenylphenylene sulfide), poly-(tolylphenylene sulfide), poly(benzylphenylene sulfide), poly[octyl-4-(3-methylcyclopentyl)phenylene sulfide], and a combination thereof.

7. The method of claim 1, wherein the poly(arylene sulfide) (PAS) is a poly(para-phenylene sulfide) (PPS) comprising least 50 mol % of recurring units (R_{PPS}) of formula (A):

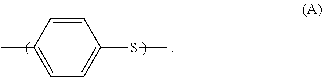

8. The method of claim 1, wherein the ethylene copolymer impact modifier comprises at least 50 wt. % of ethylene repeat units and 50 wt. % or less of repeat units comprising a (meth)acrylate group.

9. The method of claim 1, wherein the ethylene copolymer impact modifier comprises ethylene/acrylate/glycidyl methacrylate, ethylene/glycidyl methacrylate, ethylene/ethylene butyl acrylate, ethylene/ethylene acrylate, ethylene/methyl acrylate, or a combination thereof.

10. The method of claim 1, wherein the polymer composition further comprises a reinforcing filler.

11. A polymer composition made by the method of claim 1.

12. The polymer composition of claim 11, wherein the polymer composition exhibits a notched-Izod impact resistance of at least 10 kJ/m² as measured according to ISO 180/A.

13. The polymer composition of claim 11, wherein the zinc is ionically bonded to the PAS poly(arylene sulfide) (PAS).

14. A shaped article comprising a polymer composition made by the method of claim 1.

15. A process for making a shaped article comprising injection molding or 3D printing a polymer composition made by the method of claim 1.

16. The method of claim 10, wherein the polymer composition further comprises a glass fiber.
